(19) United States
(12) Patent Application Publication
(10) Pub. No.: US 2006/0167594 A1
(43) Pub. Date: Jul. 27, 2006

(54) Vehicle reverse warning and distance measurement system

(76) Inventor: Pat Y. Mah, Hong Kong (CN)

Correspondence Address: Curt Harrington, Suite 250, 6300 State University Drive, Long Beach, CA, 90815, US

(21) Appl. No.: 11/040,903

(22) Filed: Jan. 21, 2005

(51) Int. Cl. G06F 17/00

(52) U.S. Cl. 701/1; 701/96; 340/903; 340/435

(57) ABSTRACT

A reverse mode detection system provides an extremely inexpensive system which can be installed in seconds and which can be used by drivers to gauge the distance from the rear of the vehicle to an object, possible an array of objects, and to provide an optional combination of a soft alert or a distance reading which the user can optionally use to assist in reverse movements of an vehicle. One advantage of the system not before seen is some indication of the rear clearance space left available to the user in backing, and a multi storage calibration ability to enable more precise backing with regard to previously calibrated objects. The ability of the reverse warning and measurement system to actually be used on an vehicle with broad acceptance is based upon its mounting system, simplicity and energy sources which are self contained and conserving of power. The distance sensor is mounted in a frame shaped structure for attachment adjacent the license plate. The frame shaped structure will follow the license plate size which is typically a standard size for different countries. A transmitter associated with the reverse light wiring and illumination system can optionally activate the system in order to conserve battery power.

### FIELD OF THE INVENTION

The present invention relates to the field of distance measurement and safe vehicle operation and more particularly to a user installable rearward looking distance measuring device with calibration which enables users to have an instant reading of the closeness of objects to the rear of a vehicle, while providing for installation by ordinary users.

### BACKGROUND OF THE INVENTION

A number of systems have been available for safety and accident prevention in automobiles. Almost all of the systems attempt to override driver control, and like most extremely complex innovations, are more likely to add problems to automobile ownership and increase automobile down time than the advantages are worth. As an example, an attempt has been made to provide radar devices which prevent a sleepy driver from approaching a parked car at high speed on the freeway. The problem with this system is that the car may lock the brakes when passing a parked car on the side of the freeway. This type of system has advances which attempt to focus the detection of an automobile to a direction directly head on to the automobile. This type of system has been fraught with problems, as no one who drives an automobile with this system would tolerate even one instance of a mis-triggering of an extreme stop on the freeway.

Even more importantly, the degree of sophistication of such devices and the degree of integration into the automobile system, the required compatibility along with the labor make the system technically prohibitive and cost prohibitive. Other systems have used infrared to detect movement of humans about a parked vehicle, along with strategic placement of infrared sensors and a highly integrated display to indicate to the driver that the vehicle is being approached.

Rearward relative object measurement has not been practically realized. The problem has been combining the method of distance measurement, the level of integration and the degree of operator attention and override involved. Integration into the braking system is impractical, but the degree of wiring and electrical integration remains problematic. Further, objects and structures which are added to a vehicle must generally comply with jurisdictional laws which govern the placement of objects onto the exterior of an automobile.

None of the above solutions for a driver give any real advantage. It should be remembered that for humans operating any form of machinery, the human, his weaknesses and strengths must be factored in. In backing an automobile, the driver has an opportunity to go slowly, can stop the vehicle and use mirrors and other structures to assess his rearward progress, and perhaps may, if traffic allows, leave the vehicle to inspect the rearward progress. Therefore, the focus has erroneously been placed upon control of the braking system and perhaps in providing distracting warnings.

### SUMMARY OF THE INVENTION

The reverse mode detection system provides an extremely inexpensive system which can be installed in seconds and which can be used by drivers to gauge the distance from the rear of the vehicle to an object, possible an array of objects, and to provide an optional combination of a soft alert or a distance reading which the user can optionally use to assist in reverse movements. One advantage of the system not before seen is some indication of the rear clearance space left available to the user in backing. Because of the different types of vehicles and the different configurations of the rear areas of vehicles upon which the system may be mounted, a calibration feature allows users to calibrate the unit especially with regard to the type of object which the user is likely to encounter most often.

As an example, where a driver needs to back into garage or a walled parking space, and especially the same space again and again, a readout can be calibrated based upon the placement of the automobile in a position in which the driver does not want to exceed and this position can be zeroed. Further, if this is one of three or four situations the driver is likely to encounter, he can store and retrieve the “zeroed” values for several such situations for maximum utility. Thus, where the driver wants to approach a wall in his work parking space, he can view the last foot or so of movement on his distance monitor and approach the optimum parking distance with precision.

The ability of the reverse warning and measurement system to actually be used on automobiles with broad acceptance is based upon its mounting system. The mounting structure for the present system, enables quick installation. The distance sensor is mounted in a frame shaped structure for attachment adjacent the license plate. The frame shaped structure will follow the license plate size which is typically a standard size for different countries. In the United States, for example, the standard license plate size is about twelve inches wide and about six inches high. The U.S. license plates have mounting apertures, two at the top and two at the bottom of the license plate. The use of these apertures is recommended to insure that the frame structure (1) resists theft, and (2) maintains a stable fixed structure. An alternative option is for the use of powerful magnets in the frame structure itself which can be used in addition to the mounting apertures, and which can facilitate the use of the frame structure in a mobile sense, such as with rental cars or in other instances where the user is not expected to take the time for a permanent installation.

The frame structure contains batteries and electronics which will both power a distance measuring device as well as a transmitter to transmit the distance information to the user inside the automobile. This topography of use enables several advantageous modes of operation. Batteries may be saved by providing a switching logic based upon (1) driver control of the on/off rear frame sensor, (2) a reverse motion sensor, (3) a periodic “ping” signal to see if there is any objects in the immediate vicinity, and (4) an inactivity mode which may use a sensor to enable a long cutoff span of time during which the vehicle is parked and/or not running.

### BRIEF DESCRIPTION OF THE DRAWINGS

The invention, its configuration, construction, and operation will be best further described in the following detailed description, taken in conjunction with the accompanying drawings in which:

FIG. 1 is a plan view of a frame structure having peripherally inwardly extending attachment lugs for affixation adjacent and about the periphery of a license plate;

FIG. 2 is a sectional view taken along line 2-2 of FIG. 3 and illustrating one possible location of components inside the frame housing structure;

FIG. 3 is a sectional view taken along line 3-3 of FIG. 1 and illustrrates the depth of the frame housing structure and housing of electronic components;

FIG. 4 is a plan view of a display unit with optional support plate for mounting upon a steering wheel column gear shift ring;

FIG. 5 is a block diagram representation of one possible combination of the components of the automobile reverse warning and distance measurement system;

FIG. 6 is a view of one possible embodiment of a transmitter tab sensor which both senses and uses the electrical connection to one of the backup lights to trigger activation of the reverse sensor set;

FIG. 7 is a sectional view of the transmitter tab of FIG. 6, taken along line 7-7 of FIG. 6;

FIG. 8 is a closeup view of a flexible layered conductor system for deriving power through a voltage drop;

FIG. 9 is a plan view of a further embodiment of the transmitter tab with a pair of conductors for deriving power through a voltage potential;

FIG. 10 is a further embodiment of a transmitter tab for insertion into a bulb socket having a center conductor;

FIG. 11 is a is a transmitter socket housing for use with a reverse lamp using wedge bulb;

FIG. 12 is a sectional view taken along line 12-12 of FIG. 11;

FIG. 13 is a transmitter housing uses ultra thin traces for attachment to any ordinary reverse lamp exposed conductors;

FIG. 14 is a bottom view of the transmitter housing seen in FIG. 13; and

FIG. 15 is a perspective view of a flexible optically driven transmitter which may be used by adhering to an ordinary reverse lamp.

### DETAILED DESCRIPTION OF THE PREFERRED EMBODIMENT

In general, automobile reverse warning and distance measurement system 9 is shown within a frame housing structure 11 is provided which can fit adjacent a vehicle's license plate which is shown in background as having the license number 1DAKA. The format shown is an American Automobile license plate format having a dimension of about six inches high by about twelve inches wide. Other formats can be used, including the European standard of a much wider and less high license plate shape.

The important element to note in FIG. 1, as well as the other drawings, is the accommodation of the space into which an automobile license plate 13, and thus the frame housing structure 11 must fit. In extreme cases, and for some vehicles, the license plate 13 fits into an area restricted on all four sides. In other cases the license plate 13 can have an upper restriction only or a lower restriction only. As a result, to insure that the frame housing structure 11 can be used in all configurations of vehicle, the frame housing structure 11 has to have an outer dimension which generally matches and does not significantly extend beyond the license plate 13.

The height profile of the frame housing structure 11 in the direction of the viewer can be significantly extended except in cases where the frame housing structure 11 must fit partially underneath some restriction intended only for thin objects like the license plate 13 itself. These mounting restrictions are rare, however having most of the height profile on only one of the major length sides to give the frame housing structure 11 an ability to be mounted in two positions which are inverted with respect to each other.

The following description corresponds to locations seen in the frame housing structure 11 shown in FIG. 1, but it is understood that the general principle is to supply all of the needed structure within the outer periphery of the license plate 13. Further, the frame housing structure 11 can be provided as a single housing into which the user can emplace batteries, or it can have a plug in battery pack which preferably forms a continuous preferably non-identifiable connection with the frame housing structure 11.

In the view of FIG. 1, the frame housing structure 11 provides an opening 15 through which the license plate 13 is visible. Within the frame housing structure 11, magnets may be mounted to be magnetically attracted to either the license plate 13 or any metal plate behind it. However, it is expected that the threaded members or other securing fasteners used in conjunction with the license plate apertures will similarly be used to connect with a series of four peripherally inwardly directed lugs 17, 19, 21, & 23. The topological motif seen in FIG. 1 includes both a periphery limited to the outer periphery of the license plate 13, and an opening 15 which is as open as possible to avoid obscuring the information printed on the license plate 13. Similarly, the lugs 17, 19, 21, & 23 are designed to be as narrow as possible and as limited in length as possible to enable engagement with securing members (not shown) which similarly engage a set of four through apertures 25 which are shown as extending completely through the lugs 17, 19, 21, & 23 and the license plate 13. Further, depending upon the material chosen, one or more of the lugs 17, 19, 21, & 23 can be eliminated for simplicity and ease of mounting. For example, if only lugs 17, & 23 were present, and if the material of the frame housing structure 11 had sufficient integrity, two threaded members would be sufficient to hold automobile reverse warning and distance measurement system 9.

In most ordinary installations, both the frame housing structure 11 and the license plate 13 will be secured, the frame housing structure 11 secured onto the license plate 13 with threaded members having large, flattened profile heads. Where the frame housing structure is accessible from the outside, the lugs 17, 19, 21, & 23 are preferably oriented such that support lug support will help secure the frame member 11 against the license plate 13 so as to bolster the ability to enclose the components.

The specifics of the outward profile of the frame housing structure 11, which is in fact a housing for the internal electronics of the automobile reverse warning and distance measurement system 9, can vary widely. Depending upon which techniques are chosen to sense the surroundings and which techniques are chosen to power the electronics, the outward appearance of the frame housing structure 11 may vary depending upon need. For example, some forms of electromagnetic radiation will transparently propagate through even a black plastic housing. For sensing white light (and the energy derived from it) some areas of the frame housing structure 11 may be transparent to visual light. Where the frame housing structure 11 is made of metal, another appearance may be dictated dependent upon the internals, and their ability to project and receive power and signals as necessary. The frame shape of the frame housing structure 11 can offer the advantages of a loop as well as a cylinder. Frame housing structure 11 somewhat lengthy cylindrical extent opens the possibility for serial arrangement of a wide array of components and sensors. The extended loop shape can be used to good advantage electromagnetically in the ability to form a wide variety of antennas from which, and into which signals may be propagated.

To the left side of FIG. 1, a solar array 27 is shown extending vertically down the left side of the frame housing structure 11. In the configuration shown, enough of the solar array 27 will be exposed regardless of which orientation the frame housing structure 11 is placed, such that the solar array 27 ends up on the right or left side. Further, the vertical extent of the solar array 27 insures that even if it is partially shaded from the sun that enough of it will be exposed to enable sufficient power to be obtained from light energy.

On the top of the frame housing structure 11 one realization of an external antenna 29 is shown. External antenna can include a thin profile metal which is layered onto an insulating layer on top of the frame housing structure 11. An external antenna 29 should be necessary perhaps only if the frame housing structure 11 is made of a material which would block the frequencies selected for use. Otherwise, an internal antenna could be used. An external antenna 29 may eliminate the need to worry about internal feedback and may be end fed or center fed antenna. External antenna 29 may be inset within a slot, and possibly covered with a thin layer potting material to protect it.

On the right side of the frame member 11, one possible configuration of sensor placement is shown as a pair of sensors including sensor 35 and 37. Sensors 35 and 37 are seen as oval structures, but their location need not even be discernible from the exterior of the frame housing structure 11. Sensors 35 and 37 are shown as separated to emphasize the inventive strategies which derive from incorporating automobile reverse warning and distance measurement system 9 into a frame housing structure 11.

First, where the sensors 35 and 37 are of the same type, the spaced apart location enables a more adequate vertical coverage. Where a license plate 13 mounting area is over a bumper, and with respect to the configuration shown in FIG. 1, at least one of the sensors, such as sensor 35 can survive to remain high over the lower bumper. Likewise, where a handle, light or other structure overlies the automobile reverse warning and distance measurement system 9 frame housing structure 11, a sensor, such as sensor 37 can survive to remain free from obstruction.

Where sensors 35 and 37 are sonic, the sensors 35 and 37 can be modulated to achieve a best combination for the mounting configuration. For example, if some object is near the upper sensor 35 creating “splatter” or multiple echoes, control circuitry (not yet shown) can combine to shift the operation to the sensor 37. Further, where neither of the sensors 35 and 37 are interfered with, they can be used in tandem to produce the best verification of distance. Two sensors can be phased to “focus” upon the object being tracked. The “focus” effect can be almost instantaneous. If the action of the top sensor 35 gives a return time of t1, and if the bottom sensor gives a return time of t2, the sensors 35 and 37 can be “phased” to produce a combined effect.

Sonic sensors, particularly operate by measuring the return time for a sonic pulse. The two sensors 35 and 37 can have phase delayed pulses of different frequency or of the same frequency to produce a higher intensity return signal in order to “track” an object, or to have its signal predominate over the others. Typically the closest signal is used, but where there is interference, or where an object which is changing its return time (such as an object moving with respect to the sensors), it can be phased to insure that it remains the highest priority return signal. Further, linear “window” openings of return times can be used to blank out unwanted and spurious signals by providing detection only within a window corresponding to the return time of interest (which relates to objects within a defined range from the sensors 35 and 37).

Further, controlled and phased doppler action can be used which further focusses upon moving objects, especially under the assumption that an object moving toward the sensors 35 and 37 is of most pronounced interest. To further illustrate an example for horizontal difference, a pair of sensors 39 and 41 are seen along the bottom of the frame housing structure 11. Sensors 39 and 41 have greater separation and are capable of a grosser degree of phasing. Further, where the approaching object of interest lies to one side of the vehicle, such phasing will enable more accurate tracking. Further, and especially when backing up for parallel parking, the point of closest approach may be to one side, and phasing will enable the closest point to be concentrated upon.

In the configuration seen in FIG. 1, the automobile reverse warning and distance measurement system 9 frame housing structure 11 can be tried in both its right side up configuration, as well as inverted to see if either position works better with some indication of placement based upon potential obstruction or interference. Further, although shown with two sets of separated sensors, 35, 37, 39 and 41, an automobile reverse warning and distance measurement system 9 can have several sensors and located multiply within the frame housing structure 11.

Where electromagnetics is used, the sensors, 35, 37, 39 and 41 can emit infrared light or pulsed light with a measurement of light return time to indicate distance. Again, doppler techniques can be used as well as phasing and smart sensing with the use of computer control.

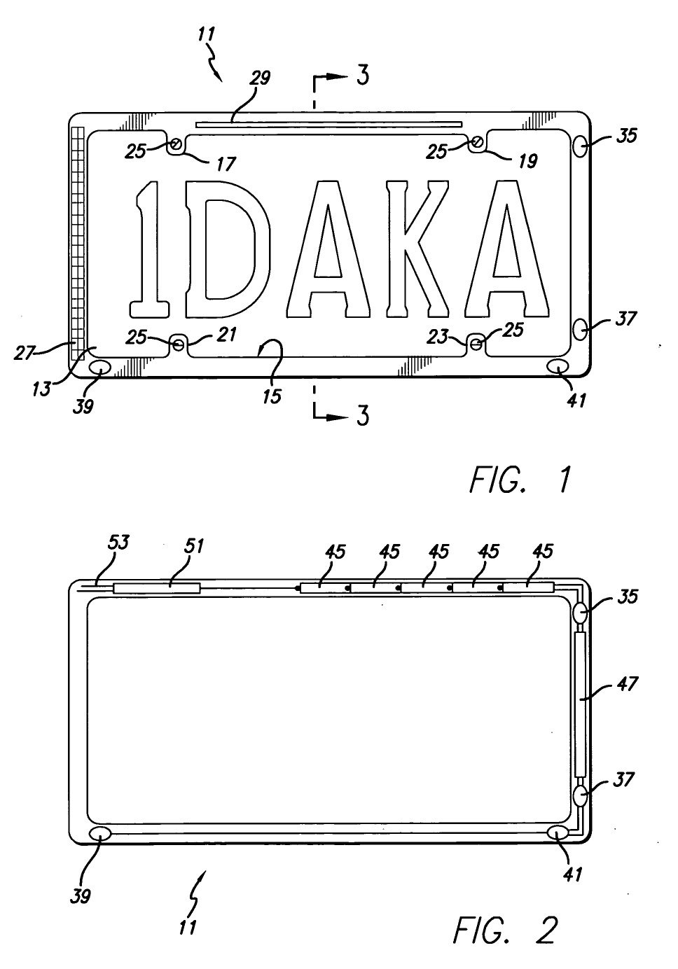

Referring to FIG. 2, a sectional view, looking into the space within the frame member 11 shows one of several possibilities in terms of the number and type of possible sensors 35, 37, 39 and 41 and other components are is shown. At the top of the frame housing structure 11 are a series of batteries 45 which may be “AAA” sized batteries for their small diameter and ability to fit within a linear section of the frame housing structure 11, and may preferably be re-chargeable, especially where the solar array 27 is to be used for supplying re-charging energy.

It is important for the batteries 45 to be in a position to be protected from moisture and the elements. Note that the placement of sensors 35, 37, 39 and 41, as well as the batteries 45 are preferably arranged so that the frame housing structure 11 can be mounted right side up or upside down without impairing the operation of the automobile reverse warning and distance measurement system 9.

To the right, an electronics section 47 is shown in electrical communication with sensors 35, 37, 39 and 41. Each of the sensors 35, 37, 39 and 41 may include a self contained energy emitter and energy receiver. In the alternative the placement of the sensors 35, 37, 39 and 41 may include different placement for the sensor energy transmitters, for example one of sensors 35 and 37 as a transmitter and the other of sensors 35 and 37 as a receiver. In some cases having an energy transmitter displaced a distance from the energy receiver can provide advantages. Likewise, the use of several sensors 35, 37, 39 and 41 placed around the automobile reverse warning and distance measurement system 9 frame housing structure 11 can provide further optimization.

In addition, any electromagnetic sensors which operate within the infrared range can also give an indication of human movement when the automobile reverse warning and distance measurement system 9 is on. A special alarm can be used when infrared sources traverse laterally with respect to the sensors 35 and 37 as a recorded trasversing movement would not be expected during backing a vehicle unless the vehicle was backing up in an area free of obstruction. Most reverse operation of a vehicle is done either in close quarters, at a gradually changing angle (as in parallel parking), or in a more open space generally straight (like backing into a parking space). Where such anoptional infrared type sensors are used, a transmitter may provide, separately or in combination, infrared illumination pulses for measuring distances, as well as a zoned sensor for giving an indication of human movement when the automobile reverse warning and distance measurement system 9 is on. Zoning can be achieved by an additional detector having a fresnel lens, or other zoned lens oriented to focus detection activity on an object moving from left to right. A special alarm, such as a separate computational threshold, can be used when infrared sources traverse laterally with respect to the sensors 35 and 37 as this would not be expected during backing a vehicle unless the vehicle was backing up in an area free of obstruction.

To the left of batteries 45, a transmitter controller 51 is shown. Transmitter controller 51 is connected to the batteries 45 and to the electronics section 47. The electronics section 47 may be dedicated to the operation of the sensors 35, 37, 39 & 41. The Transmitter controller 51 is preferably dedicated to receive an indication of distance from the electronics section 47 and to transmit the information through either an internal antenna (not shown) if the frame housing structure 11 is transparent to electromagnetic transmission energy, and to external antenna 29 if the frame housing structure 11 is not transparent to electromagnetic transmission energy.

Even though the automobile reverse warning and distance measurement system 9 frame housing structure 11 will likely be mounted in a direction facing away from the rear of a vehicle, with a receiving unit (to be described) being in the opposite direction, the electromagnetic transmission waves will be able to reflectively enter the passenger compartment of the vehicle by reflection off of other objects, as well as the entry into the rear window of the vehicle. It is remembered that near field transmissions are enabled to more directly propagate into the passenger space of a vehicle. A pair of conductors extending from the transmitter controller 51 may connect to the solar array 27 which is shown as removed. The control of the charging of the batteries 45 may be controlled by either the transmitter controller 51 or by the electronics section 47. In addition, where the transmitter controller 51 is a transceiver controller 51, it can be used to provide a manual on-off function. In order to save power, it may be desirable to insure that the

automobile reverse warning and distance measurement system 9 remains in an inactive state until and unless the driver wishes to activate it. Other awakening mechanisms can be employed to signal the automobile reverse warning and distance measurement system 9 to begin measurements.

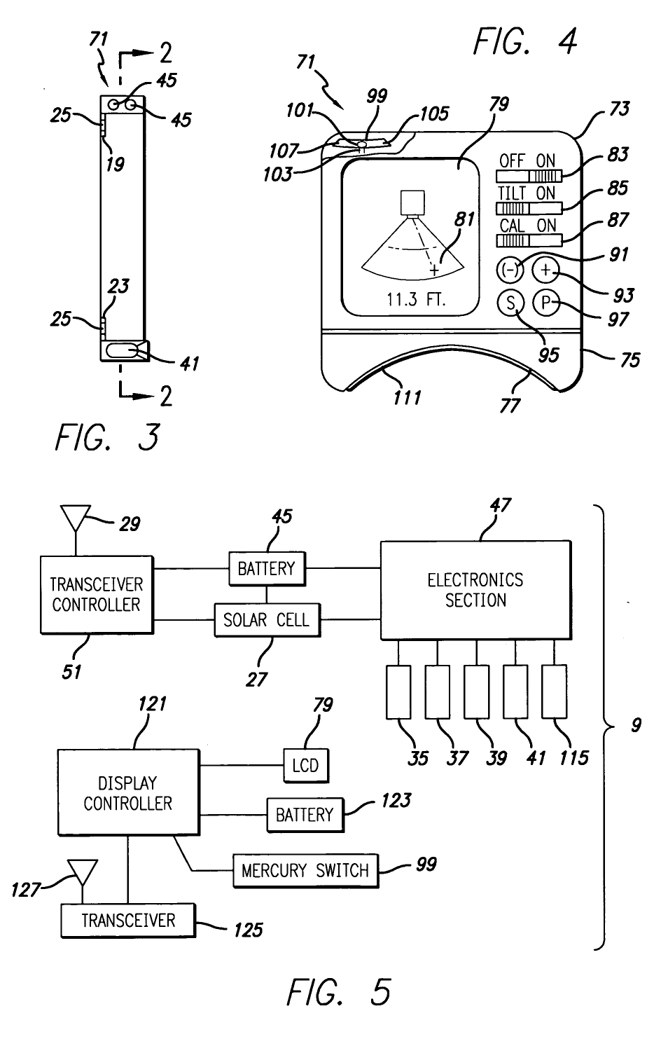

Referring to FIG. 3, one possible side view of the automobile reverse warning and distance measurement system 9 frame housing structure 11 is seen along line 3-3 of FIG. 2. The view of FIG. 3 emphasizes that the depth of the frame housing structure 11 can be much deeper than its peripheral width. The depth is seen as being about two to three times the peripheral width, and supports two lines of batteries 45. The extension of the lugs 19 and 23 are clearly seen, along with apertures 25 for mounting the frame housing structure 11. At the bottom, one of the sensors 41 is seen. Note that the sensor is positioned on the rearward face of the frame housing structure 11, so that it will have a more rearward exposure and better, less obstructed wide angle coverage to the rear of the vehicle.

Referring to FIG. 4, a driver's display unit 71 is shown has having an upper housing 73 and a lower optional support plate 75 having a lower curved surface 77. Other features on the display unit 71 include a liquid crystal display screen 79 (which may be illuminated) which may have a physical representation of a vehicle and an angular representation of the sweep area scanned by the automobile reverse warning and distance measurement system 9. Where the capability is present, the screen 79 may show the distance and location of several objects, and not just the closest object. It may also have the ability to produce a visual representation of an object, shown by a small symbol “+” 81 shown on the screen 79. Screen 79 should also be enabled to indicate the distance of the closest object in an alpha numeric display portion of the screen seen as “11.3 FT”.

Other aspects of the display unit 71 include an off/on switch 83, a tilt on/off switch 85 and a calibrate on/off switch seen with the words “cal on” and labeled 87. A minimalist input function set might include buttons labeled as a minus button, “(−)” 91, a plus button “+” button 93, an “S” button 95 and a “P” button 97.

In addition, for dedicated operation, a center close mercury switch 99 is shown in a cut away section of the upper portion of the display unit 71. Most automatic vehicles have a collar which surrounds the steering column and which moves when the selector column moves. The position when going from “Drive” to “Reverse” involves a slight movement of the collar a couple of degrees to the left. When placed in tilt on mode, the automobile reverse warning and distance measurement system 9, which includes the display unit 71, will remain shut off to conserve power. When the automobile drive lever is placed in Reverse, the display unit 71 achieves a centered, upright position, and the electronics are switched on. The switching on of the display unit 71 may include a sampling override which keeps the automobile reverse warning and distance measurement system 9 functioning despite any temporary movement of the automobile which would cause the center close mercury switch 99 to temporarily open, even while the display unit 71 is upright, such as lateral forces from movement of the automobile.

Likewise, a temporary movement override can be used to ignore momentary closure of the switch from lateral force due to automobile cornering. Because the angular movement of the driving column is so slight, the center close mercury switch 99 will necessarily be of slight angular curvature. As another feature to combat unintentional triggering during cornering, a set of left side and right side contacts can provide an over ride to keep the unit shut off for at least one second as the mercury bead 101 moves between the center contacts 103, a set of right contacts 105 and a set of left contacts 107.

In normal usage, a parked car will cause the mercury bead 101 to move to position 107 and will insure that the unit is off, that the automobile reverse warning and distance measurement system 9 upper housing 73 electronics remain off and that the electronics within the frame housing structure 11 are not signaled and remain un-activated. When in drive, the upper housing 73 will be tilted to the right, and the contacts 105 will normally remain closed while sensing the presence of the mercury bead 101 while automobile straight travel is achieved.

However, normal driving with normal cornering will cause the mercury bead 101 to move back and forth. Hard cornering will cause the bead 101 to close the contacts 105 and 107. Highway driving will cause the bead to generally keep contact 105 closed, but may cause the bead to move to the center contact 103 momentarily. Because of the one or two second over ride, a lane change which might perhaps enable the bead 101 to remain in residence on the contacts 103 for almost a second, will not cause the electronics within the display unit 71 to either start up, nor will it enable the electronics within the display unit 71 to send a signal to the electronics (electronics section 47 or transmitter controller 51) within the frame housing structure 11.

All that a user need do is use an adhesive foam pad to mount the support plate 75 onto the gear change collar associated with the gear shift lever in the upright position, when the ignition is off and when the gear shift lever is moved to park. Such integration will enable the display unit 71 of the automobile reverse warning and distance measurement system 9 to become an essentially permanent part of the driver's instrumentation. Because the display unit 71 is small and mounted forwardly with respect to the other instruments in an automobile, no obstruction will be had with respect to the other instruments in the auto.

The tilt on switch 85 enables the tilt feature. A simple shutting off of the tilt feature permits complete manual operation with the on/off switch 83. In this way, the same upper housing 73 can be used in a more permanent and a less permanent mode. The upper housing 73 may be made detachable from the lower housing 75 to facilitate battery change or to enable the display unit 71 to be used by others. The detachability feature is especially useful for calibration.

During calibration, the “cal on” switch 87 is moved to the on position. Because of the mobility of the display unit 71, the calibration can be performed outside the vehicle. As an example, suppose a driver wanted to make certain that he parked a known distance from an object, and positioned the automobile the exact distance from the object desired. The operator could press the program button 97 and by using the “(−)” and “+” buttons come to a program storage location where the calibration is to be entered. A +/0/− convention could be used in liquid crystal display screen 79 in the program location for future reference to help the driver achieve the exact location he selected during the calibration process. If the location was a wall, he would be able to move to the storage area where the calibration occurred and then moved to the desired location, precisely, every time.

The calibration is also used because a variety of sensors, and conditions may give a different three dimensional reading for each type of object. A brick wall may have a slightly different reading than a vertical pole. An overhang may give a weak reading, and the calibration feature will enable the unit to sense the desired calibration distance based upon a variety of signal conditions, and not just the most prominent return from the closest object. The calibration selection, for example, may use a combination of one sonic sensor and one infrared time reflex domain sensor with the calibration based upon a pair of targeted distances as well as a comparison ratio between them.

The foregoing being an example of a focussed calibration, the programming of the electronics within the liquid crystal display screen 79 is also ideally subject to a more general calibration especially since the rearward looking profile of each automobile is different. Some license plates 13, and therefore the frame housing structure 11, will be mounted at different angles on some vehicles, and others have varying restrictions. Calibration may include a first open field calibration where the vehicle is parked completely away from all obstructions in order to get a base line to account for any signal distortion with respect to the mounting limitations, and a second calibration where the vehicle is backed against and touching a wall. This will enable a real conditions default calibration based upon the distance from the most rearward end of the bumper of the vehicle and the inward displacement of the frame housing structure 11.

Although it is likely that the objects encountered will not always have a flat wall profile, the base line calibration lets the operator know at least a base line distance. In the case of another vehicle having a bumper protruding about 5 inches and where the main part of the vehicle behind the vehicle equipped with the automobile reverse warning and distance measurement system 9 is closer to the frame housing structure 11 than the bumper, the driver of the car equipped with the automobile reverse warning and distance measurement system 9 may make contact with the other rearward vehicle a few inches before the previously indicated calibrated “zero” distance. This may happen for any lower protruding object which protrudes low and provides a an open upper clearance.

However, the automobile reverse warning and distance measurement system 9 will have its greatest use where drivers can avoid hardened objects like walls and steel posts. Further, however, where the automobile reverse warning and distance measurement system 9 will be used more often with parking, a calibration can be performed based upon a measurement in front of a vehicle which is expected to be encountered. One of the expected uses of the keys 91-97 is to enable the storage of calibration profiles. The user can ideally switch from one calibration profile to anther depending upon the situation encountered. In this manner, the user can select from a number of pre-stored calibration profiles to enable a much more exacting operation of his vehicle.

Of all the situations encountered, the parallel parking situation will likely have the greatest individual variance from a standard calibration mode, and because the adjacent automobiles are expected to vary the most in terms of their forward shape profile, the driver will have to be more careful and rely less on the indication appearing on the liquid crystal display screen 79. However, inasmuch as the parallel parking typically involves a very low movement velocity and some intended bumping, and driver feel, the automobile reverse warning and distance measurement system 9 will probably not have as high a driver utility in this instance. The expected highest incidences of use involve darkened spaces into which the vehicle is backed into and unknown areas into which the vehicle is backed. The need for the automobile reverse warning and distance measurement system 9 is especially high where a driver goes from bright daylight to a darkened garage area and where the driver's eyes have not sufficiently adjusted to a level which will permit judging the distance.

Referring to FIG. 5, a block diagram outlining one possible topology for the automobile reverse warning and distance measurement system 9. Elements shown already include sensors 35, 37, 39 & 41. An additional sensor 115 represents multiple other sensors which may exist singly or in integration with the sensors 35, 37, 39 & 41. Note that the solar cell 27 and battery 45 may be connected directly or through the electronics section 47 and or transceiver controller 51. Either of the electonics section 47 and or transceiver controller 51 may include voltage increase circuitry. The upper part of FIG. 5 includes a lot of structure seen in FIGS. 1 and 2. The other possible block structures associated with the upper housing 73 includes a display controller 121 which may preferably be a single microprocessor control circuit for all of the components of the display unit 71. Display controller 121 is shown is in connection with the LCD display 79, and the mercury switch 99. Other components not shown earlier include a battery 123 and a transceiver 125 controllably connected to the display controller 121 and having an antenna 127 connected to the transceiver 125. All of the sleep functions and other programming functions associated with operation of the display unit 71, including switches 83-97 will preferably be controlled by the display controller 121.

One desirable implementation of the automobile reverse warning and distance measurement system 9 is to provide for limited activation of the system. An automatic activation is always preferred, but beyond the mounting of the display unit 71 on the gear shift column, the user will have to take installation steps beyond the simple affixation of a license plate frame. During reverse operation of a functioning vehicle, power is supplied to the backup lights, which are typically white light incandescent emitters. Access to backup lights are supplied to ordinary users typically through the trunk. An open trunk typically exposes an internally located lamp housing space into which fits a backup lamp socket assembly. A burned out light is typically replaced by the user by opening the trunk, pulling out the lamp socket assembly from its specially designed lamp housing space, and then replacing the lamp in the lamp socket manually, and then replacing the lamp socket assembly by insertion into its opening into the lamp housing space.

Placing the automobile into reverse results in two measurable aspects associated with the lamp housing space. First, when the automobile is running and placed into reverse mode, electricity is supplied to the reverse lamps. Second, the area within the lamp housing space is instantly bathed in bright white light. Both of these measurable aspects of the reverse lamp operation can be used to activate the automobile reverse warning and distance measurement system 9.

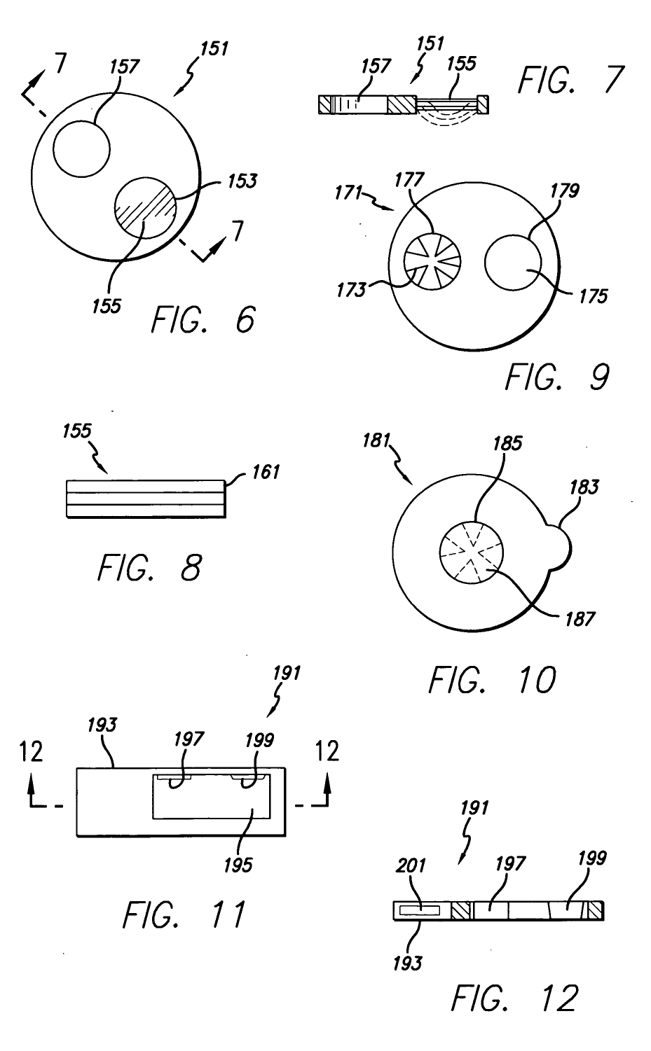

What is to be avoided if possible is to cause the ordinary user to change the electrical system of the vehicle by tapping in or other potentially dangerous activity. Reverse lamps have many configurations, the top three being center conductor, parallel spaced apart conductors and wedge socket. One device which can use the electrical power supplied without the necessity for doing more than would be required for a bulb change for parallel conductors is the use of a very thin transmitter tab 151 as is shown in FIG. 6. Transmitter tab 151 includes an open conducting area 153 which exposes a flexible, deformable conductor 155 which may be a sandwiched material.

A circuit located inside the transmitter tab 151 need only transmit a very short range signal to a receiver in the electronics section 47 in order to instruct it to activate the automobile reverse warning and distance measurement system 9. It should be remembered that in this mode, it may be preferably for the transmitter controller 51 to also transmit to the display unit 71 to activate it as well. One mode for transmission of the transmitter tab 151 may be by a simple square wave, carrying no intelligence other than its signal.

Power may be derived by placement of the transmitter tab 151 into the base of a lamp socket manually followed by the replacement of the bulb. The open conducting area 153 can be centered where the bulb has a center conductor, or it may have an additional open space 157 where a pair of side by side conductors are used. In the case of side by side conductors, the two knobs on the bottom of a lamp will register the transmitter tab 151 and help orient it in the socket. FIG. 7 illustrates a cross sectional view with the possible deformation of the deformable conductor 155 shown in dashed line format.

In terms of taking power, a transmitter within the transmitter tab 151 can be voltage or current driven. Where a single membrane material as a deformable conductor 155 is used, a sandwich of materials produces a slight voltage drop as current passes through the material. An example is seen in FIG. 8 which shows one possible configuration for the deformable conductor 155 as having an upper near zero resistance layer 161, a middle slight resistance layer 163, and a lower near zero resistance layer 165. Where current flows through the deformable conductor 155, a voltage will be developed between the layers 161 and 165 which may be sufficient to drive a transmitter (not shown).

An alternative embodiment is seen in FIG. 9, where a transmitter tab 171 is voltage driven and uses a pair of conductors 173 and 175 which are housed within open conducting areas 177 and 179, respectively. In this configuration, the transmitter would operate from the voltage differences between the two conductors 173 and 175. As an alternative, conductor 173 is shown as being made of a more resilient metal with a star cutout pattern which may still make contact with a lamp terminal while permitting the bulk of the lamp terminal to pass through.

A further alternative embodiment is seen in FIG. 10 for a center conductor lamp. A transmitter tab 181 is thin and circular for fitting within a lamp socket. The transmitter tab 181 has a periphery which will contact the metal inside area of a lamp socket (not shown). In addition, it may have a thin deformable projection 183 to further insure that contact is made with the inside of the lamp socket (not shown). At the center of the transmitter tab 181 is a conducting area 185 with a conductor 187 which may be a deformable conductor or it may be a star shape (shown by the dashed line indicator) to permit contact with the center conductor of a lamp and a lamp socket (both not shown).

The wedge type lamp often has conductors which are build into the glass lower envelope of the lamp and which may protrude externally above the neck of the extent of the insertion stop located on the lamp. In this case, a thin, push through clip could be used to capture contact from the bulb. Referring to FIG. 11, a transmitter socket housing 191 has a side volume 193 for housing the electronics for the transmitter circuitry, and a central through opening 195 within which a pair of conductors 197 and 199 can be seen.

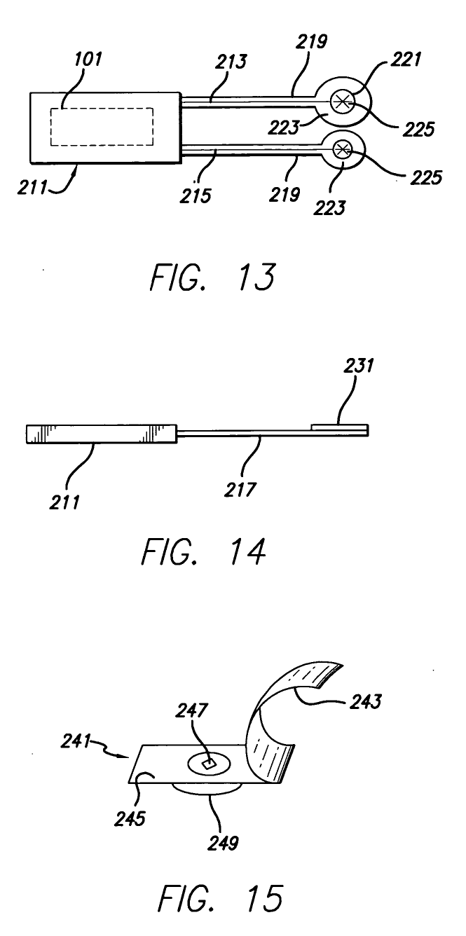

Referring to FIG. 12, a sectional view taken along line 12-12 of FIG. 11 illustrates the very thin profile of the transmitter socket housing 191 and illustrates the inside of the electronics volume 193 and shown with electronic circuitry 201 inside.

Referring to FIG. 13, a more universal transmitter can be provided with conducting adhesive contacts for fitting onto any type of reverse bulb. A transmitter housing 211 with electronic circuitry inside has a pair of extremely thin, flexible circuit traces, including a first trace 213 and a second trace 215. Each of the traces 213 and 215 are completely insulated by an outer covering of flexible circuit material 219 or the like and is extremely flat. It is contemplated that the traces 213 and 215 may be attached to any exposed conductor of a lamp and inserted back into the lamp's socket with adequate clearance.

Each of the traces 213 and 215 may be exposed on one side of an expanded end of the circuit material, and may be covered with a release strip until ready for installation. The ends of the traces are expanded into a slightly enlarged circular area 221 supported by a slightly enlarged partially circular area 223 of the flexible circuit material 223. A star cut 225 may be made at the time of manufacture into the enlarged circular areas 221 to facilitate a fit over any post type plug in terminals. The exposed slightly enlarged circular areas 221 of the traces 213 and 215 may have conductive adhesive applied. Referring to FIG. 14, a side profile of the transmitter housing 211 of FIG. 13 is illustrated. A release layer 231 is used to expose the conducive adhesive and exposed slightly enlarged circular areas 221 of the traces 213 and 215.

For installation, a user simply removes his reverse bulb and identifies some exposed area of the conductors of the bulb. Where a prong or other conductive structure has a small area, it can be pushed through the star cut 225 far enough to insure that it makes contact through to the other side. Where a needle shaped prong is exposed, the star cut will allow the prong to slip through, maintaining electrical contact while not covering the remainder of the prong needed for direct electrical contact between the prong and the lamp socket.

Lastly, and referring to FIG. 15, a photocell transmitter 241 is shown. A release layer 243 exposes a face 245 of a flexible material having a photocell 247 at the center. The face 245 is preferably adhesive coated so that it can be adhered advantageously to the rear side of the reverse bulb. An electronics pod 249 is seen which houses a transmitter and other circuitry. The adhesive and flexible structures enable the photocell transmitter 241 to be positioned closely adjacent the bulb in a position to receive not only photo-electric energy, but to receive the optimum net difference sense between the bulb being on and off. Circuitry within the electronics pod 249 can also be used to sense the step rise and step fall in light levels so that it can start and stop transmitting at the proper time. The circuitry may have charge storage capacity so that it can act more intelligently on startup, such as by actively detecting a threshold which must be exceeded to trigger a radio signal. With the photocell transmitter 241, the automobile circuit need not be tapped in any form.

While the present invention has been described in terms of a distance sensing and warning system which provides automobile drivers with an indication of objects to the rear of their vehicle, and especially for enabling drivers to, with precision, repeat the parking process using an indicator in addition to other visual observation, including mirrors and a turn around view through the rear vehicle window, the present invention may be applied in any situation where the degree of integration of a system is matched with the needs of a user and designed to facilitate actual use at a helpful level rather than a system wide integration to actually lower utility.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. An vehicle reverse warning and distance measurement system comprising:
a frame housing structure for mounting about the periphery of a license plate;
a distance sensor mounted within said frame housing structure and directed away from said frame housing structure;
a controller electrically connected to said distance sensor;
at least a first controller transmitter connected to said controller;
a display unit for use inside a passenger compartment of an vehicle further comprising at least a display unit receiver for receiving signals from said at least a first controller transmitter indicative of a distance of at least one object from said frame housing structure.

2. The vehicle reverse warning and distance measurement system as recited in claim 1 and wherein said display unit further includes a display unit transmitter for activating said controller within said frame housing structure.

3. The vehicle reverse warning and distance measurement system as recited in claim 2 and wherein said display unit further includes tilt sensor for activating said display unit transmitter when said frame housing structure is tilted.

4. The vehicle reverse warning and distance measurement system as recited in claim 1 and further comprising a reverse light transmitter associated with activation of an vehicle reverse lamp for activating said controller within said frame housing structure in response to energization of said vehicle reverse lamp, in order to conserve operation of said distance sensor, controller and first transmitter.

5. The vehicle reverse warning and distance measurement system as recited in claim 1 and wherein said display unit receiver can also receive a signal from said reverse light transmitter to energize said controller upon the occurrence of an activation of said reverse light.

6. The vehicle reverse warning and distance measurement system as recited in claim 1 and further comprising at least one battery for powering said distance sensor, controller and first transmitter.

7. The vehicle reverse warning and distance measurement system as recited in claim 2 and further comprising at least one solar array for supplying power to said at least one battery.

8. The vehicle reverse warning and distance measurement system as recited in claim 1 wherein said distance sensor is an electromagnetic distance sensor.

9. The vehicle reverse warning and distance measurement system as recited in claim 1 wherein said distance sensor is a sonic distance sensor.

10. The vehicle reverse warning and distance measurement system as recited in claim 4 wherein said reverse light transmitter associated with activation of an vehicle reverse lamp is in electrical communication with energization conductors associated with said vehicle's reverse lamp wiring.

11. The vehicle reverse warning and distance measurement system as recited in claim 4 wherein said reverse light transmitter associated with activation of an vehicle reverse lamp is optically activated by illumination of said vehicle reverse lamp.
